(19) United States
(12) Patent Application Publication
(10) Pub. No.: US 2021/0277491 A1
(43) Pub. Date: Sep. 9, 2021

(54) CRYOGENIC LASER SHOCK STRENGTHENING METHOD AND APPARATUS BASED ON LASER-INDUCED HIGH TEMPERATURE PLASMA TECHNOLOGY

(71) Applicant: JIANGSU UNIVERSITY, Jiangsu (CN)

(72) Inventors: Jianzhong ZHOU, Jiangsu (CN); Xiankai MENG, Jiangsu (CN); Chun SU, Jiangsu (CN); Jie SHENG, Jiangsu (CN); Jiale XU, Jiangsu (CN); Shu HUANG, Jiangsu (CN); Jing LI, Jiangsu (CN)

(21) Appl. No.: 16/332,752

(22) PCT Filed: Sep. 21, 2016
(86) PCT No.: PCT/CN2016/099514

§ 371 Date: Mar. 12, 2019

(30) Foreign Application Priority Data
Sep. 12, 2016 (CN) 201610817206.2

(51) Int. Cl. C21D 6/04; C21D 10/00; C22F 3/00; B23K 26/0622; B23K 26/12; B23K 26/356; B23K 26/144

(52) U.S. Cl. CPC C21D 6/04; C21D 10/005; C22F 3/00; B23K 26/144; B23K 26/127; B23K 26/356; B23K 26/0622

(57) ABSTRACT

A cryogenic laser shock strengthening method and apparatus based on a laser-induced high temperature plasma technology includes: liquid nitrogen doped with absorber powder is irradiated using high power laser beams, to generate partial high temperature plasma, the liquid nitrogen quickly vaporizes and expands under the action of the high temperature plasma to form high-speed high-pressure air streams, and the high-speed high-pressure air streams shock a metal surface in a low temperature environment to implement the strengthening of the surface. In addition, continuous pressure accumulation of a vaporization cavity can be implemented by means of multiple laser pulses to further increase the shock wave pressure of a metal surface, thereby improving the surface strengthening effect of the metal surface.

### TECHNICAL FIELD

The present invention relates to the fields of surface strengthening and laser processing technology, particularly to a cryogenic laser shock strengthening method and apparatus using laser-induced high temperature plasma technology.

### BACKGROUND ART

The cryogenic laser shock technology utilizes the ultra-low temperature and high strain rate coupling effect to significantly improve the microstructure and residual stress state of the material, and greatly improve the fatigue resistance performance and wear and corrosion resistance performance of the material. However, due to the influence of the absorbing layer and the constraining layer, there are still some key technical problems such as low laser energy utilization and low shock wave pressure in the cryogenic laser shock process.

At present, the constraining layer in the laser shock strengthening process can be divided into two categories: the rigid constraining layer and the flexible constraining layer. A common rigid constraining layer is an optical glass. For example, the invention patent with patent No. CN201110422502 proposes a strengthening method and device for metal material using cryogenic laser shock, which uses K9 glass as a constraining layer to realize cryogenic laser shock strengthening, but the following disadvantages still exist: (1) the water in the air at low temperature will be adsorbed on the optical glass to faun water droplets or ice particles, reducing the light transmittance of the optical glass and thereby seriously reducing the energy utilization rate of laser; (2) K9 glass is prone to crack or completely fracture under shock wave pressure at low temperature, which affects the constraining effect of laser shock waves. Common flexible constraining layers include water, silicone oil and other transparent materials, for example, the invention patents with patent No. CN200510094810 and No. CN201310527671 use water curtain and silicone oil as constraining layer for laser shock strengthening technology respectively. Water in normal temperature environment and silicone oil in high temperature environment can obtain a better shock strengthening effect, but the fluidity of these flexible media is limited at low temperature, these flexible media even condense to solid state, such that the light transmittance is seriously reduced, and the constraining effect is also significantly reduced.

Since liquid nitrogen is a colorless and transparent medium with a high light transmittance, the patent application with the application No. CN105063284A uses liquid nitrogen as a refrigerant as well as a constraining layer, and proposes a cryogenic laser shock head and a laser shock system with high light transmittance, improving the light transmittance of laser by thermal insulation ceramic/plastic and vacuum insulation method, and thus increasing the shock wave pressure. However, the following deficiencies still exist: (1) the absorbing layer is aluminum foil, so the laser absorption rate of shot peening area is reduced due to vaporization of the aluminum foil when the overlapping rate is high or the impact is repeated for multiple times, and thereby the utilization rate of laser energy is reduced and the shock wave pressure is weakened; (2) the shock wave pressure is completely dependent on the power density of the laser beam, so the method is difficult to be applicable to surface strengthening treatment of superhard materials due to the limitation of energy of the laser device.

The present invention provides a cryogenic laser shock strengthening method and device using laser-induced high temperature plasma technology, which can break through the limitation of the absorbing layer and the constraining layer, and therefore, higher laser energy utilization and higher shock wave pressure than conventional laser shock strengthening methods are obtained. After searching the literatures in China and abroad, no surface strengthening method and apparatus by using laser-induced high temperature plasma to generate liquid nitrogen for vaporization expansion have been found, and no related reports regarding use of corresponding method in the field of cryogenic laser shock strengthening have been found. The method and device are proposed for the first time in the present invention.

### CONTENT OF THE INVENTION

In order to overcome the shortcomings in the prior art, the present invention proposes a cryogenic laser shock strengthening method and apparatus using laser-induced high temperature plasma technology, which can effectively avoid the blocking effect of liquid nitrogen vapor on laser in the liquid nitrogen environment in conventional laser shock strengthening technology, and significantly increase the shock wave pressure on metal surface by combining the expansion pressure of the laser-induced plasma with the vaporization pressure of the liquid nitrogen, thereby effectively increasing the surface strengthening effect.

The present invention achieves the above technical objects by the following technical means.

A cryogenic laser shock strengthening method based on laser-induced high temperature plasma technology, characterized in that, a high-power laser beam is used to irradiate liquid nitrogen doped with absorber powders, and local absorber powders absorb the high-power laser and rapidly vaporize to generate high-temperature plasma; the high temperature plasma rapidly expands and promotes rapid vaporization and expansion of the surrounding liquid nitrogen to form a high-speed and high-pressure air stream; the plasma expansion pressure and the liquid nitrogen vaporization expansion pressure cause the pressure of vaporization chamber to rise rapidly, and the surface is strengthened by impacting the metal surface in a low temperature environment.

Furthermore, different regions of the metal surface are repeatedly impacted with the high-power laser beam, to achieve regional strengthening of the surface of a sample.

Furthermore, the high-power laser beam is a pulsed laser beam, and continuous pressure accumulation of vaporization chamber is implemented by a plurality of laser pulses, that is, the pressure of a plurality of laser-pulse-induced plasmas and the liquid nitrogen vaporization pressure are repeatedly overlapped to increase the shock wave pressure on the surface of the sample and improve the impact strengthening effect.

Furthermore, the absorber powders are black paint powders with an average diameter of no more than 200 μm or aluminum powders with an average diameter of no more than 100 μm; the volume ratio of powder to liquid nitrogen in liquid nitrogen doped with absorber powders is 0.1 to 0.3.

Furthermore, the high-power laser beam is a nanosecond laser beam with a pulse width of 10 to 100 ns and a low temperature environment is kept within −85 to −176° C.

The cryogenic laser shock strengthening apparatus for cryogenic laser shock strengthening method, characterized in that, it comprises a laser shock system, a liquid nitrogen circulation system and a control system, wherein the laser shock system comprises a laser device, a total-reflection mirror, a cryogenic impact head, a vertical workbench, a horizontal bracket, a motion platform, a manual adjustment knob and a workbench, the motion platform is mounted on the workbench, the laser device is placed horizontally, the total-reflection mirror is located on the optical path of the laser emitted by the laser device and is disposed at 45° relative to the horizontal plane, the laser enters the cryogenic impact head vertically after being reflected by the total-reflection mirror, and the cryogenic impact head is fixed on the vertical workbench by the horizontal bracket, and the height of the vertical workbench in the vertical direction can be adjusted;

the liquid nitrogen circulation system includes a high-pressure liquid nitrogen container, a powder mixing device, the cryogenic impact head, a cryogenic tank, a nitrogen separation device and a nitrogen liquefaction device which are connected successively by a liquid nitrogen transporting line 22, the nitrogen liquefaction device is also connected with the liquid nitrogen container by the liquid nitrogen transporting line, the cryogenic tank is fixed on the motion platform, the powder mixing device is provided with a V-shaped funnel for storing the absorber powders, the funnel mouth of the V-shaped funnel extends into the powder mixing device, the V-shaped funnel is provided with a screw extending into the cylindrical funnel mouth, and the screw is driven to rotate by a servo motor located at the top of the V-shaped funnel;

the control system includes a computer, a temperature sensor and an electromagnetic flow valve, the temperature sensor and the electromagnetic flow valve are connected to the computer, the temperature sensor is disposed in the cryogenic tank and located on the surface of a sample to be processed for collecting the temperature of the surface of the sample; the electromagnetic flow valve is disposed on the liquid nitrogen transporting line between the cryogenic tank and the nitrogen separation device, the computer adjusts the flow rate of the electromagnetic flow valve according to a setting temperature so as to control the height of liquid level of liquid nitrogen, thereby realizing surface temperature control of the sample; the laser device, the motion platform, the vertical workbench and the servo motor are all connected to the computer, and the parameters of laser generated by the laser device, the height of the vertical workbench in the vertical direction, the movement track of the motion platform and the spiral powder feeding efficiency of the screw are all controlled by the computer; a manual knob is also provided at one end of the motion platform for manually adjusting the starting position of the motion platform.

Furthermore, the powder mixing device is internally provided with a serpentine passage.

Furthermore, the cryogenic impact head comprises a main body, an outer end cover, a sleeve, an inner end cover, a first high-pressure resistant glass and a second high-pressure resistant glass, the main body has a laser chamber and a vaporization chamber which are communicated with each other, the first high-pressure resistant glass is disposed between the laser chamber and the vaporization chamber, and separates the laser chamber from the vaporization chamber; the sleeve is mounted in the laser chamber, the inner end cover is mounted on the outer end cover and the second high-pressure resistant glass is limited between the inner end cover and the outer end cover; the outer end cover is in threaded connection with the opening of the laser chamber; sealing washers are provided between the outer end cover and the sleeve, between the outer end cover and the second high-pressure resistant glass, and between the laser chamber and the first high-pressure resistant glass respectively, to make the laser chamber become an airtight space; the side wall of the laser chamber is provided with a suction hole in communication with an air extractor, and the side wall of the vaporization chamber is provided with a liquid nitrogen inlet and an outlet in communication with the liquid nitrogen transporting line; and the inlet and the outlet are respectively provided with a first electromagnetic valve and a second electromagnetic valve, the opening or closing of the first electromagnetic valve and the second electromagnetic valve is controlled by the computer, and a pressure valve is set at the nozzle in the lower end of the vaporization chamber of the main body of the cryogenic impact head, and the pressure valve is in threaded connection with the main body of the cryogenic impact head.

Furthermore, the distance between the cryogenic impact head and the sample is 6 to 20 mm; and the pressure of the high pressure liquid nitrogen container is not less than 50 Mpa.

Furthermore, an L-shaped bracket is disposed between the horizontal bracket and the vertical workbench.

The working principle of the method in the present invention is using high power laser beams to irradiate the liquid nitrogen doped with the absorber powder, to generate a local high-temperature plasma, and the liquid nitrogen rapidly vaporizes and expands under the action of high-temperature plasma to form a high-speed and high-pressure air stream, which impacts on the surface of metal in low temperature environment to achieve surface strengthening. The method avoids the hindering effect of liquid nitrogen vapor on the laser in the liquid nitrogen environment in the conventional laser shock strengthening technology and improves the utilization rate of laser energy; the shock wave pressure on the metal surface is significantly increased by combining the expansion pressure of the laser-induced plasma with the vaporization pressure of the liquid nitrogen.

Combined with the motion track of the motion platform, the high-power laser beam is used to impact different areas of the metal surface for multiple times, to achieve regional strengthening of the sample surface.

By adjusting the opening pressure of the pressure valve 3-11 of the cryogenic impact head, the pressure of plasma induced by the plurality of laser pulses and the liquid nitrogen vaporization pressure can be repeatedly overlapped, thereby significantly increasing the shock wave pressure on the surface of the sample and improving the impact strengthening effect.

### DESCRIPTION OF DRAWINGS

FIG. 1 is a schematic diagram of a cryogenic laser shock strengthening apparatus based on laser induced high temperature plasma technology according to the present invention.

FIG. 2 is a schematic diagram of the cryogenic laser impact head.

FIG. 3 is a schematic diagram of the working principle of the cryogenic laser impact head.

In the Figures,

1. Laser device, 2. 45° reflection mirror, 3. cryogenic impact head, 4. L-shaped bracket, 5. stud, 6. horizontal bracket, 7. vertical workbench, 8. stud, 9. motion platform, 10. manual adjusting knob, 11. inlet adapter, 12. temperature sensor, 13. sample, 14. cryogenic tank, 15. outlet adapter, 16. electromagnetic flow valve, 17. outlet adapter, 18. nitrogen separation device, 19 nitrogen liquefaction device, 20. workbench, 21. high-pressure liquid nitrogen container, 22. liquid nitrogen transporting line, 23. inlet adapter, 24. absorber powder, 25. funnel top cover, 26. computer, 27. servo motor, 28. high-precision screw, 29. V-shaped funnel, 30. powder mixing device, 31. serpentine passage, 3-1. first electromagnetic valve, 3-2. first high-pressure resistant glass, 3-3. sleeve, 3-4. inner end cover, 3-5. second high-pressure resistant glass, 3-6. sealing washer, 3-7. outer end cover, 3-8. main body, 3-9. suction hole adapter, 3-10. second electromagnetic valve, 3-11. pressure valve.

### Embodiments

The present invention is further described below with reference to the figures and embodiments, but the scope of the present invention is not limited thereto.

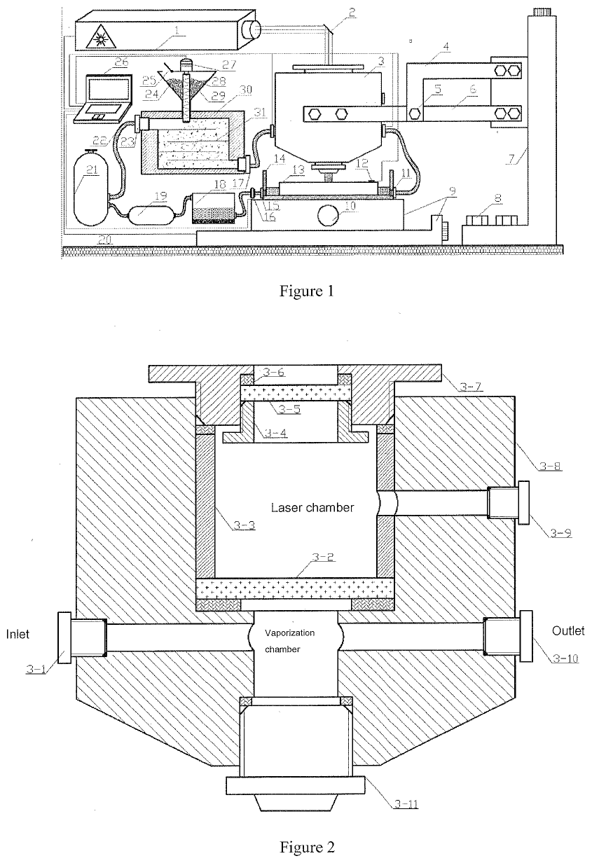

As shown in FIG. 1, the cryogenic laser shock strengthening apparatus based on laser-induced high temperature plasma technology of the present invention comprises a laser shock system, a liquid nitrogen circulation system and a control system, wherein the laser shock system comprises a laser device 1, a total-reflection mirror 2, a cryogenic impact head 3, a vertical workbench 7, a horizontal bracket 6, a motion platform 9, a manual adjustment knob 10 and a workbench 20, the motion platform 9 is mounted on the workbench 20, the laser device 1 is placed horizontally, the total-reflection mirror 2 is located on the optical path of the laser emitted by the laser device 1 and is disposed at 45° relative to the horizontal plane, the laser enters the cryogenic impact head 3 vertically after being reflected by the total-reflection mirror 2, and the cryogenic impact head 3 is fixed on the vertical workbench 7 by the horizontal bracket 6, and the height of the vertical workbench 7 in the vertical direction can be adjusted.

The liquid nitrogen circulation system includes a high-pressure liquid nitrogen container 21, a powder mixing device 30, the cryogenic impact head 3, a cryogenic tank 14, a nitrogen separation device 18 and a nitrogen liquefaction device 19 which are connected successively by a liquid nitrogen transporting line 22, the nitrogen liquefaction device is also connected with the liquid nitrogen container 21 by the liquid nitrogen transporting line, the cryogenic tank 14 is fixed on the motion platform 9, the powder mixing device 30 is provided with a V-shaped funnel 29 for storing the absorber powders 24, the funnel mouth of the V-shaped funnel 29 extends into the powder mixing device 30, the V-shaped funnel 29 is provided with a screw 28 extending into the cylindrical funnel mouth, and the screw 28 is driven to rotate by a servo motor 27 located at the top of the V-shaped funnel 29.

The control system includes a computer 26, a temperature sensor 12 and an electromagnetic flow valve 16, the temperature sensor 12 and the electromagnetic flow valve 16 are connected to the computer 26, the temperature sensor 12 is disposed in the cryogenic tank 14 and located on the surface of a sample 13 to be processed for collecting the temperature of the surface of the sample 13; the electromagnetic flow valve 16 is disposed on the liquid nitrogen transporting line 22 between the cryogenic tank 14 and the nitrogen separation device 18, the computer 26 adjusts the flow rate of the electromagnetic flow valve 16 according to a setting temperature so as to control the height of liquid level of liquid nitrogen, thereby realizing surface temperature control of the sample 13; the laser device 1, the motion platform 9, the vertical workbench 7 and the servo motor 27 are all connected to the computer 26, and the parameters of laser generated by the laser device 1, the height of the vertical workbench 7 in the vertical direction and the movement track of the motion platform 9 are all controlled by the computer 26; a manual knob 10 is also provided at one end of the motion platform 9 for manually adjusting the starting position of the motion platform.

The cryogenic laser shock strengthening method based on laser-induced high temperature plasma technology uses high power laser beams to irradiate the liquid nitrogen doped with the absorber powders, and local absorber powders absorb the high-power laser and rapidly vaporize to generate high temperature plasmas. The high temperature plasma rapidly expands and promotes rapid vaporization and expansion of the surrounding liquid nitrogen to form a high-speed and high-pressure air stream. The plasma expansion pressure and the liquid nitrogen vaporization and expansion pressure cause the pressure in the vaporization chamber to increase rapidly, resulting in impact on the metal surface in a low temperature environment and achieving surface strengthening. The hindering effect of liquid nitrogen vapor on the laser in the liquid nitrogen environment in conventional laser shock strengthening technology is avoided, the utilization rate of laser energy is improved; and the laser-induced plasma expansion pressure is combined with the liquid nitrogen vaporization pressure to significantly increase the shock wave pressure on the metal surface. The absorber powders are black paint powders with an average diameter of not more than 200 μm or aluminum powders with an average diameter of not more than 100 μm; the volume ratio of powder to liquid nitrogen in liquid nitrogen doped with absorber powders is 0.1 to 0.3. The high-power laser beam is a nanosecond laser beam with a pulse width of 10 to 100 ns and a low temperature environment is kept within −85 to −176° C.

During the working process, the laser beam generated by the laser device 1 is reflected by the 45° total-reflection mirror 2 and then vertically enters the cryogenic impact head 3, and the laser device parameters can be precisely controlled by the computer 26 in real time. The distance between the cryogenic impact head 3 and the sample 13 can be adjusted by the vertical workbench 7. The stud 5 is connected between the horizontal bracket 6 and the cryogenic impact head 3, between the horizontal bracket 6 and the L-shaped bracket 4, between the horizontal bracket 6 and the vertical workbench 7, and between the L-shaped bracket 4 and the vertical workbench 7. The liquid nitrogen in the high-pressure liquid nitrogen container 21 is transported to the powder mixing device 30 through the liquid nitrogen transporting line 22, and the powder mixing device 30 are connected with the liquid nitrogen transporting line 22 through an inlet adapter 23. The V-shaped funnel 29 is mounted on the powder mixing device 30 for storing the absorber powder 24. The screw 28 provided in the middle of the V-shaped funnel 29 is driven to rotate by the servo motor 27, to send the absorber powder 24 to the powder mixing device 30 in a spiral feeding manner, and the spiral powder feeding efficiency can be controlled by using the computer 26 to adjust the rotation speed of the servo motor 27.

The powder mixing device 30 is internally provided with a serpentine passage 31, and the absorber powder 24 and the liquid nitrogen are rapidly mixed in the powder mixing device 30 through the serpentine passage 31, and the liquid nitrogen doped with the absorber powder is transported to the liquid nitrogen inlet of the cryogenic impact head 3 through the adapter 17 and the liquid nitrogen transporting line, and is transported from the liquid nitrogen outlet to the inlet of the cryogenic tank 14 through the liquid nitrogen transporting line, and the inlet of the cryogenic tank 14 is provided with an adapter. The liquid nitrogen in the cryogenic tank 14 is transported to the nitrogen separation device 18 through the liquid nitrogen transporting line after passing through the outlet adapter 15 and the electromagnetic flow valve 16, and the nitrogen gas generated by the nitrogen separation unit 18 is transported to the nitrogen liquefaction device 19 through the transporting line, and recovered to the liquid nitrogen container 21 through the liquid nitrogen transporting line. The sample 13 is placed in the cryogenic tank 14, and the temperature sensor 12 on the surface of the sample 13 feeds back the temperature of the surface of the sample 13 to the computer 26 through the data line in real time. The cryogenic tank 14 is fixed on the motion platform 9. One end of the motion platform 9 is provided with a manual knob 10, and the motion path of the motion platform 9 can be controlled by the computer 26.

As shown in FIG. 2, the cryogenic impact head 3 comprises a main body 3-8, an outer end cover 3-7, a sleeve 3-3, an inner end cover 3-4, a first high-pressure resistant glass 3-2 and a second high-pressure resistant glass 3-5, the main body 3-8 has a laser chamber and a vaporization chamber which are communicated with each other, the first high-pressure resistant glass 3-2 is disposed between the laser chamber and the vaporization chamber, and separates the laser chamber from the vaporization chamber. The sleeve 3-3 is mounted in the laser chamber, the inner end cover 3-4 is mounted on the outer end cover 3-7 through threaded connection and the second high-pressure resistant glass 3-5 is limited between the inner end cover 3-4 and the outer end cover 3-7; the outer end cover 3-7 is in threaded connection with the opening of the laser chamber; sealing washers are provided between the outer end cover 3-7 and the sleeve 3-3, between the outer end cover 3-7 and the second high-pressure resistant glass 3-5, and between the laser chamber and the first high-pressure resistant glass 3-2 respectively, to make the laser chamber become an airtight space. The side wall of the laser chamber is provided with a suction hole in communication with an air extractor, an adapter 3-9 is arranged outside the suction hole and connected with the air extractor to ensure that the laser chamber is in vacuum state. The side wall of the vaporization chamber is provided with a liquid nitrogen inlet and an outlet in communication with the liquid nitrogen transporting line 22; and the inlet and the outlet are respectively provided with a first electromagnetic valve 3-1 and a second electromagnetic valve 3-10, the opening or closing of the first electromagnetic valve 3-1 and the second electromagnetic valve 3-10 is controlled by the computer 26. The pressure valve 3-11 is in threaded connection with the main body 3-8 of the cryogenic impact head. The distance between the cryogenic impact head 3 and the sample 13 is 6 to 20 mm. The pressure of the high-pressure liquid nitrogen container 21 is not less than 50 MPa.

The surface temperature of the sample 13 is controlled by the height of liquid level of liquid nitrogen of the cryogenic tank 14. The specific process is: the temperature sensor 12 collects the surface temperature of the sample 13 and feeds back to the computer 26, and the computer 26 adjusts the flow rate of the electromagnetic flow valve 16 according to the setting temperature to control the height of liquid level of the liquid nitrogen, which determines the contact area and the heat transfer efficiency of the sample with the liquid nitrogen, thereby controlling the surface temperature of the sample.

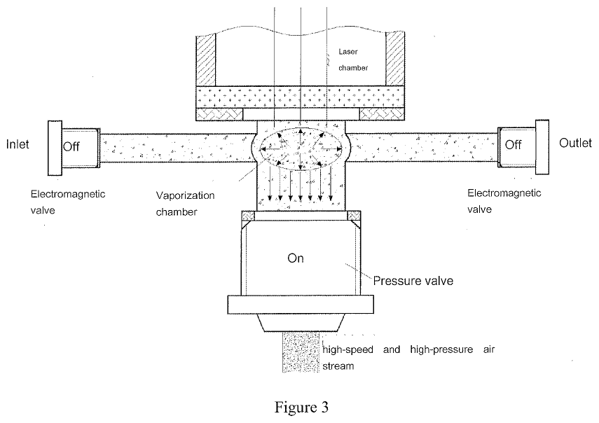

The working principle of the cryogenic laser impact head is shown in FIG. 3. The computer 26 controls the first electromagnetic valve 3-1 and the second electromagnetic valve 3-10 at the inlet and outlet of the cryogenic impact head to open, and the liquid nitrogen doped with absorber powders enters into the vaporization chamber, and liquid nitrogen flows to the cryogenic tank 14 through the outlet due to insufficient opening pressure of the pressure valves 3-11. Under the control of the computer 26, the surface of the sample 13 reaches the setting temperature, then the computer 26 controls the first electromagnetic valve 3-1 and the second electromagnetic valve 3-10 at the inlet and outlet of the cryogenic impact head 3 to close, at the same time the laser device 1 emits laser which enters the vaporization chamber through the laser chamber. The absorber powder absorbs the high-power laser to rapidly vaporize to form a high-temperature plasma, the high-temperature plasma rapidly expands and promotes rapid vaporization and expansion of the surrounding liquid nitrogen. The plasma expansion pressure and the liquid nitrogen vaporization and expansion pressure cause the pressure in the vaporization chamber to increase rapidly. When the vaporization chamber pressure increases to the opening pressure of the pressure valve 3-11, the high-speed and high-pressure airflow is ejected through the outlet of the pressure valve 3-11, and impacts the surface of the sample 13 at an extremely high pressure to achieve surface strengthening. Multiple impacts can be achieved by repeating the above process, and at the same time, regional strengthening of the sample surface can be achieved by combining the motion track of the motion platform 9.

By adjusting the opening pressure of the pressure valve 3-11 of cryogenic impact head, the method and the device of the present invention can realize continuous pressure accumulation in the vaporization chamber by a plurality of laser pulses, that is, the pressure of plasma induced by the plurality of laser pulses and the liquid nitrogen vaporization pressure are repeatedly overlapped, which can significantly increase the shock wave pressure on the surface of the sample, thereby improving the shock strengthening effect.

The TC6 titanium alloy is surface-strengthened by the cryogenic laser shock strengthening method and apparatus according to the present invention, wherein the high-power laser beam has a pulse width of 20 ns and an energy of 9 J. The black paint powder has an average diameter of 52 μm. The volume ratio of black paint powder to liquid nitrogen in the liquid nitrogen doped with black paint powder is 0.16. The distance between the cryogenic impact head 3 and the sample 13 is 10 mm, and the surface temperature of the sample is −160° C. The pressure of the high-pressure liquid nitrogen container 21 is maintained at 75 MPa. The surface of TC6 titanium alloy is strengthened under the same temperature and the same laser parameters using conventional laser shock strengthening method, the results show that the average depth of the pit induced by conventional laser shock strengthening is about 32 μm, while the average depth of the pit on the surface of TC6 titanium alloy in the method and apparatus of the present invention is 55 μm, which is about 71.9% higher than the conventional laser shock strengthening method, which shows that the method of the present invention can significantly improve the utilization rate of laser energy and the shock wave pressure on metal surface, thereby significantly improving the shock strengthening effect.

The embodiment is a preferred embodiment of the present invention, but the present invention is not limited to the embodiments described above. Any obvious improvements, substitutions or transformations that can be made by the person skilled in the art without departing from the essential contents of the present invention are intended to be within the scope of protection of the invention.

1. A cryogenic laser shock strengthening method based on laser-induced high temperature plasma technology comprising:
irradiating liquid nitrogen doped with absorber powders with a high-power laser beam, wherein local absorber powders absorb the high-power laser and rapidly vaporize to generate high-temperature plasma;
rapidly expanding the high temperature plasma to thereby promotes rapid vaporization and expansion of the surrounding liquid nitrogen to form a high-speed and high-pressure air stream, whereby the plasma expansion pressure and the liquid nitrogen vaporization expansion pressure causes the pressure of vaporization chamber to rise rapidly, and whereby the surface is strengthened by impacting the metal surface in a low temperature environment.

2. The cryogenic laser shock strengthening method according to claim 1, wherein different regions of the metal surface are repeatedly impacted with the high-power laser beam, to achieve regional strengthening of the surface of a sample.

3. The cryogenic laser shock strengthening method according to claim 1, wherein the high-power laser beam is a pulsed laser beam, and continuous pressure accumulation of vaporization chamber is implemented by a plurality of laser pulses, that is, the pressure of a plurality of laser-pulse-induced plasmas and the liquid nitrogen vaporization pressure are repeatedly overlapped to increase the shock wave pressure on the surface of the sample and improve the impact strengthening effect.

4. The cryogenic laser shock strengthening method according to claim 1, wherein the absorber powders are black paint powders with an average diameter of no more than 200 μm or aluminum powders with an average diameter of no more than 100 μm; the volume ratio of powder to liquid nitrogen in liquid nitrogen doped with absorber powders is 0.1 to 0.3.

5. The cryogenic laser shock strengthening method according to claim 1, wherein the high-power laser beam is a nanosecond laser beam with a pulse width of 10 to 100 ns and a low temperature environment is kept within −85 to −176° C.

6. A cryogenic laser shock strengthening apparatus for a cryogenic laser shock strengthening method comprising:
a laser shock system, wherein the laser shock system comprises a laser device, a total-reflection mirror, a cryogenic impact head, a vertical workbench, a horizontal bracket, a motion platform, a manual adjustment knob and a workbench, wherein the motion platform is mounted on the workbench, wherein the laser device is placed horizontally, wherein the total-reflection mirror is located on the optical path of the laser emitted by the laser device and is disposed at 45° relative to the horizontal plane, wherein the laser enters the cryogenic impact head vertically after being reflected by the total-reflection mirror, and the wherein cryogenic impact head is fixed on the vertical workbench by the horizontal bracket, and wherein the height of the vertical workbench in the vertical direction can be adjusted;
a liquid nitrogen circulation system including a high-pressure liquid nitrogen container, a powder mixing device, the cryogenic impact head, a cryogenic tank, a nitrogen separation device and a nitrogen liquefaction device which are connected successively by a liquid nitrogen transporting line, wherein the nitrogen liquefaction device is also connected with the liquid nitrogen container by the liquid nitrogen transporting line, wherein the cryogenic tank is fixed on the motion platform, wherein the powder mixing device is provided with a V-shaped funnel for storing the absorber powders, wherein the funnel mouth of the V-shaped funnel extends into the powder mixing device, wherein the V-shaped funnel is provided with a screw extending into the cylindrical funnel mouth, and wherein the screw is driven to rotate by a servo motor located at the top of the V-shaped funnel; and
a control system including computer, a temperature sensor and an electromagnetic flow valve, wherein the temperature sensor and the electromagnetic flow valve are connected to the computer, wherein the temperature sensor is disposed in the cryogenic tank and located on the surface of a sample to be processed for collecting the temperature of the surface of the sample, wherein the electromagnetic flow valve is disposed on the liquid nitrogen transporting line between the cryogenic tank and the nitrogen separation device wherein the computer adjusts the flow rate of the electromagnetic flow valve according to a setting temperature so as to control the height of liquid level of liquid nitrogen, thereby realizing surface temperature control of the sample, wherein the laser device, the motion platform, the vertical workbench and the servo motor are all connected to the computer, and the parameters of laser generated by the laser device, the height of the vertical workbench in the vertical direction, the movement track of the motion platform and the spiral powder feeding efficiency of the screw are all controlled by the computer; and wherein a manual knob is also provided at one end of the motion platform for manually adjusting the starting position of the motion platform.

7. The cryogenic laser shock strengthening apparatus according to claim 6, wherein the powder mixing device is internally provided with a serpentine passage.

8. The cryogenic laser shock strengthening apparatus according to claim 6, wherein the cryogenic impact head comprises a main body, an outer end cover, a sleeve, an inner end cover, a first high-pressure resistant glass and a second high-pressure resistant glass, wherein the main body has a laser chamber and a vaporization chamber which are communicated with each other, wherein the first high-pressure resistant glass is disposed between the laser chamber and the vaporization chamber, and separates the laser chamber from the vaporization chamber, wherein the sleeve is mounted in the laser chamber, the inner end cover is mounted on the outer end cover and the second high-pressure resistant glass is limited between the inner end cover and the outer end cover, wherein the outer end cover is in threaded connection with the opening of the laser chamber, wherein sealing washers are provided between the outer end cover and the sleeve, between the outer end cover and the second high-pressure resistant glass, and between the laser chamber and the first high-pressure resistant glass respectively, to make the laser chamber become an airtight space, wherein the side wall of the laser chamber is provided with a suction hole in communication with an air extractor, and the side wall of the vaporization chamber is provided with a liquid nitrogen inlet and an outlet in communication with the liquid nitrogen transporting line, wherein and the inlet and the outlet are respectively provided with a first electromagnetic valve and a second electromagnetic valve, wherein the opening or closing of the first electromagnetic valve and the second electromagnetic valve is controlled by the computer, and a pressure valve is set at the nozzle in the lower end of the vaporization chamber of the main body of the cryogenic impact head, and wherein the pressure valve is in threaded connection with the main body of the cryogenic impact head.

9. The cryogenic laser shock strengthening apparatus according to claim 6, wherein the distance between the cryogenic impact head and the sample is 6 to 20 mm; and the pressure of the high pressure liquid nitrogen container is not less than 50 Mpa.

10. The cryogenic laser shock strengthening apparatus according to claim 6, wherein an L-shaped bracket is disposed between the horizontal bracket and the vertical workbench.
